(19) United States
(12) Patent Application Publication
(10) Pub. No.: US 2019/0216273 A1
(43) Pub. Date: Jul. 18, 2019

(54) Travel Seat

(71) Applicant: Joyce Maerose Clemons, Smithfield, VA (US)

(72) Inventor: Joyce Maerose Clemons, Smithfield, VA (US)

(21) Appl. No.: 15/732,885

(22) Filed: Jan. 12, 2018

(51) Int. Cl. A47K 13/00; A47K 13/28

(52) U.S. Cl. CPC A47K 13/005; A61G 7/1007; A47K 13/28

(57) ABSTRACT

The travel seat is meant to assist those with some form of disability that hinders the use of standard size restroom commodes use. The Travel Seat can also be used by anyone without a walker. It can either give height to the commode itself or be used with a walking assistant, such as walkers by clamping or snapping onto the bars of the walker and acting as portable bathroom commode that sits on or above the toilet, depending on user. It is supported with support bars beneath it.

### CROSS REFERENCE

This application claims the benefits of Provisional Application 62/605,055 filed on Jul. 31, 2017

### BACKGROUND OF INVENTION

Today's portable pots are meant to stay put by the side of the bed or stationary above the home bathroom commodes confining clients near home at all times. Bed side commodes are bulky and unpleasant to carry to bathroom to be expelled into toilet for flushing and splash possibility. Portable potty chairs are not meant to assist anyone with walking. They are heavy and difficult to move about.

### BRIEF SUMMARY OF INVENTION

The Travel seat was thought of as an assistant whenever one with a disability condition wants to travel or get out of the house more often than usual but opt to remain at home because of the limits the disabling conditions on their bodies. The Travel Seat works together with or without a walking assistant giving the accommodations to the client's personal needs. Together with a walking assistant the travel Seat will enable one to leave their home with confidence that when they are ready to use the bathroom they could without major concern of having someone to help them on and off the commode. The seat is a convenient and portable to travel with you on long or short distance from home. The light weight plastic portable seat clamps on to the walking assistant and becomes your potty chair away from home in any public restroom. The Travel Seat is easy to clean and promotes sanitary public restroom use. The seat has light weight support bars underneath to support extra weight. The Travel Seat can be stored in a case and kept in the client's vehicle trunk to be ready for use at any time. This seat can be purchased for a child or an adult.

### BRIEF DESCRIPTION OF DRAWING

This is a brief description of the drawings. There will be a more detailed description following below.

FIG. 1 is the top view of the Travel Seat.

FIG. 2 is the bottom view of the detachable—Travel Seat with (X) amounts of grooves and support bars.

FIG. 3 is the grooved support bars

FIG. 4 is the attempt to show Travel Seat at eye level.

### DETAILED DESCRIPTION OF THE INVENTION

The following is the detailed description according to the teaching of this application in the form of a Travel Seat and is described by its use. Although this seat does travel with you, please note that because the term public will be used does not limit this seat to public restrooms only but can be accommodating in any bathroom requiring its use. The Travel Seat encourages one to get moving toward a more active healthy life style instead of being primarily home bound. Meaning it can be used in homes, vacations, outings or any place/stall it will fit. It is ideal to promote healthy activities, sanitary from unclean toilets, it is made with light weight hard plastic material and conveniently at hand, easy to apply (clamps or snaps onto most walkers), Support bars for extra weight, easy to clean and stores in a case in the trunk of the vehicle.

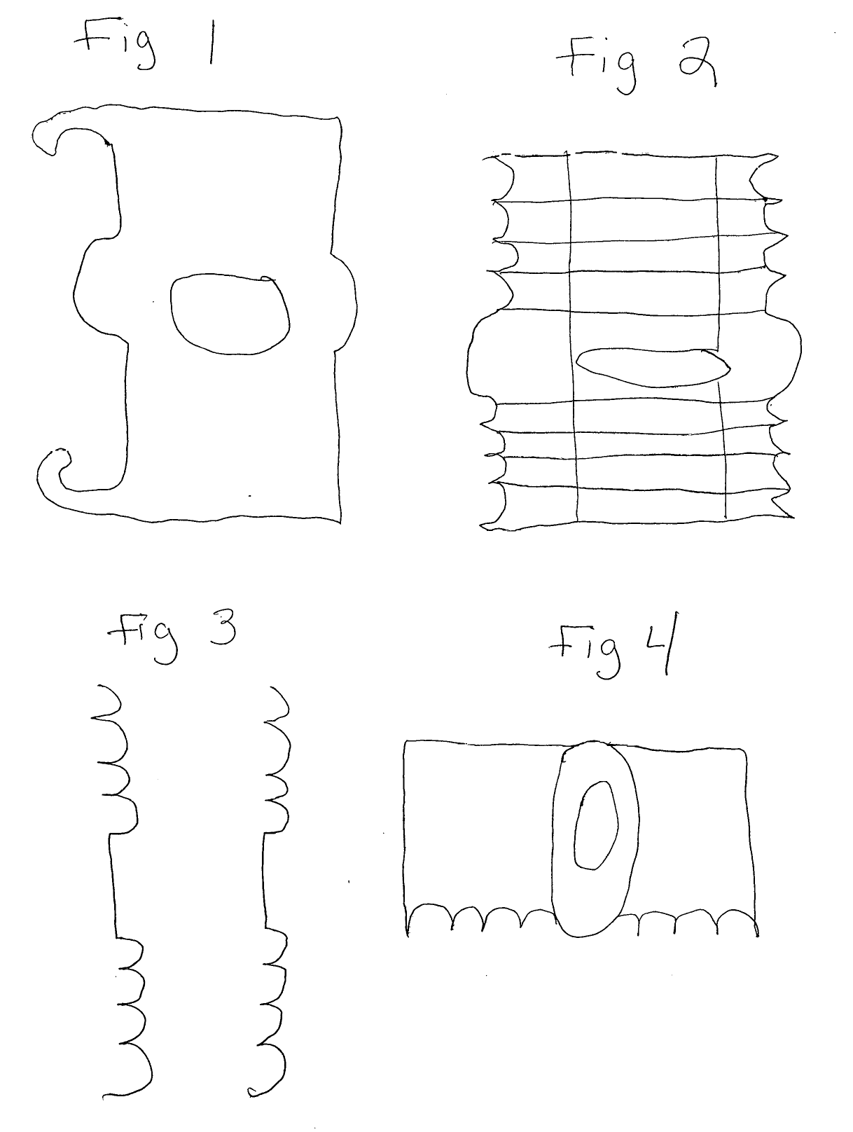

FIG. 1 shown as Drawing number 200 shows the top view of the Travel Seat where the commode portion of the seat is and its flat extension on each side across from one side of the assistant side bar to the other side bar.

FIG. 2 shown as Drawing number 201 showing the bottom view of the attachable and detachable Travel Seat with (X) amounts of grooves and (2) support bars. The grooves and the support bars are of equal grooves except beneath the seat portion where the bar is whole and support the biggest amount of clients' weight.

FIG. 3 shown as Drawing number 202 showing the support bars with (X) amounts of grooves that are equally working in grooves.

FIG. 4 shown as Drawing number 203 attempting to show eye level of front to back view with grooves indicating clamp/snap-on grooves to the side bars of the walking assistant frame and according to the desired fit of walking assistant (from small assistant to large assistant fit).

1-9. (canceled)

10. I claim a Travel Seat comprising a light weight easy to carry plastic material with a commode seat and is used with a small to large walkers.

11. The Travel Seat according to claim 1, clamps/snaps on and off the walker.

12. The Travel Seat according to claim 1, is meant to be used as a commode seat that assist in restrooms along with walkers.

13. The Travel Seat according to claim 1, has light weight support bars to support weight.
